(19) United States
(12) Patent Application Publication
(10) Pub. No.: US 2005/0021808 A1
(43) Pub. Date: Jan. 27, 2005

(54) System for broadcasting media and method for use in such a system

(76) Inventor: David, Raymond, Michel Rene, Chateau-Landon (FR)

Correspondence Address: YOUNG & THOMPSON, 745 SOUTH 23RD STREET, 2ND FLOOR, ARLINGTON, VA, 22202, US

(21) Appl. No.: 10/501,952

(22) PCT Filed: Jan. 17, 2003
(86) PCT No.: PCT/FR03/00141

(30) Foreign Application Priority Data
Jan. 21, 2002 (FR) 02/00720

(51) Int. Cl. G06F 15/16

(52) U.S. Cl. 709/231; 709/217; 719/322

(57) ABSTRACT

The invention relates to a system for broadcasting media comprising at least one client application (4) and a separate broadcasting engine (9). The planning is carried out in the client application in the form of drop-down lists comprising several media objects referring to media such as audio, video, fireworks, laser etc. The broadcasting engine receives said lists, collects and then places them in a principal list depending on provisions given in the client application. The drop-down lists may be modified in the broadcasting engine from the client application. The broadcasting engine may open several sessions, each session being related to a given media type.

The present invention relates to a media broadcasting system making use of a broadcasting engine. It has a particularly advantageous application in the production and broadcasting of radio programmes. However, the invention is of wider scope since it can be applied to any type of media capable of being broadcast. In fact, the invention can contribute to the broadcasting of audio files, video, files relating to firework launching commands, laser, etc.

There are many applications used in the production and broadcasting of radio programmes. In general, the management of a radio programme makes use of the following steps: the acquisition, production and broadcasting of media. The acquisition makes it possible to save musical files in a database. This phase uses, in particular, a digitisation of analogue data. The saved data can come from different sources and can be in different formats.

The production step makes it possible to produce a kind of schedule of programmes intended to be broadcast at a predetermined time and for a predetermined duration.

The broadcasting step relates to the actual broadcasting of radio programmes (music, speech, advertisements, etc.). It is known that this step makes use of a driver, a succession of empty time periods to be filled with programme schedules. This driver can be managed manually or automatically.

However, broadcasting engines of the prior art are often specialised for a predetermined type of media.

The objective of the present invention is a new broadcasting system capable of broadcasting a plurality of media.

Another objective of the invention is to propose a flexible broadcasting system in which the broadcast programme can be created and modified easily.

Another objective of the invention is an entirely automated broadcasting system.

The present invention therefore proposes a media broadcasting system comprising at least one client application and a broadcasting engine, characterized in that the client application comprises:
generating means for generating at least one drop-down list, this drop-down list comprising at least one media object intended for broadcasting,
transmission means for transmitting the drop-down list to the broadcasting engine,
   and in that the broadcasting engine comprises:
a broadcasting session comprising a management module capable of receiving the drop-down list coming from the client application and of inserting that drop-down list in a main list comprising a plurality of drop-down lists, and a broadcasting module capable of broadcasting the content of that main list by means of a media broadcasting device,
a supervision module for authenticating a client application wishing to access the broadcasting engine and for opening at least one broadcasting session if appropriate, and
a reference clock for synchronizing all of the components of the broadcasting engine.

According to an advantageous embodiment of the invention, the broadcasting engine and the client application are disposed in two separate processing units communicating according to a communication protocol for communication networks such as the Internet protocol (IP). Unlike the system of the prior art, in the present invention, the client application in which the broadcast programmes are planned is separate from the broadcasting engine. This allows the generation of several client applications capable of being connected to the broadcasting engine and of acting, in particular, on the main list which is the broadcasting list.

According to the invention, a drop-down list is a list consisting of media objects. A media object is a reference to a media or is the media itself. Advantageously, the invention is not restricted to a particular media type, the media can be an audio file, video, fireworks or a laser projection. More generally, the media is an event, which can be broadcast in time starting from a precise moment and for a predetermined or not predetermined duration. The duration is predetermined when it is, for example, a song recorded on a CD; it is not predetermined when the song is produced live during a concert.

The drop-down list comprises at least one media object. It can be considered as a time slot characterizing a period of broadcast time. This can be a publicity slot, a transmission, a fireworks sequence, a continuous news programme, etc.

Each drop-down list can comprise a unique identification number represented in particular by a numerical value in 64 bits.

According to an advantageous characteristic of the invention, each media object comprises a numerical value corresponding to its broadcasting position within the drop-down list. It is not obligatory for these numerical values to be series. What is notable is their progressive nature. Preferably, each numerical value is a floating point number.

Advantageously, the first media object in the drop-down list contains an absolute start time corresponding to the time of its broadcasting, this absolute start time being a number of microseconds obtained with respect to a predetermined time origin. By way of example, the predetermined time origin can be the first of January of a year such as the year 2000 and the absolute start time is an integer in 64 bits.

This absolute start time cannot be indicated when the drop-down list. is attached to a remote control message, that is to say a message coming from a control unit which can be external to the broadcasting system as defined. This can occur in the case of transmission of a synchronisation signal coming from a national radio station to regional stations when a commercial break occurs to allow broadcasting of targeted publicity. In this case, the absolute start time of the first media object is determined when the remote control message is received. In order not to waste time, this media object is sent directly for broadcasting, then the following media objects are reset and inserted in the main list for a broadcast.

Furthermore, the management module can comprise means for determining the duration of each media object and the absolute start time of that media object. The management module can also comprise means for substituting all of part of a media object in the main list by another media object.

The advantage of the drop-down lists according to the invention is that they can be processed directly in the broadcasting engine, in the main list, and this can be done even a few seconds before the broadcast.

The broadcasting engine can comprise means for opening a plurality of broadcasting session, each one being dedicated to a predetermined type of media. It can also comprise a list of drivers from which the client application chooses a driver according to the media object contained in the drop-down list transmitted to that broadcasting engine, a driver being a computer programme allowing the operating system of a computer to communicate with a specified peripheral.

In order to improve the compatibility of the broadcasting system according to the invention, the broadcasting session can comprise means for encoding any media object according to a predetermined broadcasting standard.

According to the invention, the supervision module can comprise means capable of opening a broadcasting session associated with a broadcasting device consisting of an audio broadcasting card, a video broadcasting card or a fireworks transmitter, a laser projector, or any other medium able to broadcast the media in question. For example, it is possible to mention an audio or video broadcast on the Internet in streaming mode.

According to another aspect of the invention, there is proposed a method of broadcasting media between at least one client application and a broadcasting engine, characterized in that it comprises the following steps in the client application:
generation of at least one drop-down list, this drop-down list comprising at least one media object intended for broadcasting,
transmission of the drop-down list to the broadcasting engine,
   and in that it comprises the following steps in the broadcasting engine:
reception of the drop-down list by a management module and insertion of that drop-down list in a main list comprising a plurality of drop-down lists,
broadcasting the content of that main list by a broadcasting module by means of a media broadcasting device,
authentication, by a supervision module, of a client application wishing to access the broadcasting engine and opening of at least one broadcasting session if appropriate, this session comprising, in particular, the management module and the broadcasting module, and
synchronisation of all of the components of the broadcasting engine with respect to a reference clock.

The client application accesses a broadcasting session only after being validly identified in the supervision module, for example by means of an identification number and a password.

When the client application is connected to the management module, the broadcasting engine can transmit a list containing all of the available drivers, the client application then transmits the drop-down list accompanied by drivers suitable for the broadcasting of the media objects in the drop-down list.

The management module can insert the drop-down list in the main list only in response to a command coming from the client application. The broadcasting engine can be characterized as a tool for executing commands coming from the client application.

According to the invention, at the time of the transmission of the drop-down list to the broadcasting engine, the client application can also transmit at least one absolute start time corresponding to the time of broadcasting of the first media object in the drop-down list, this absolute start time being a number of microseconds obtained with respect to a predetermined time origin.

Furthermore, at the time of the insertion of the drop-down list in the main list, the management module can determine the duration and the absolute start time of each media object.

Other advantages and characteristics of the invention will become apparent on examining the detailed description of an embodiment that is in no way limiting, and the appended drawings in which:

FIG. 1 is a simplified diagram illustrating an overall architecture of the system according to the invention;

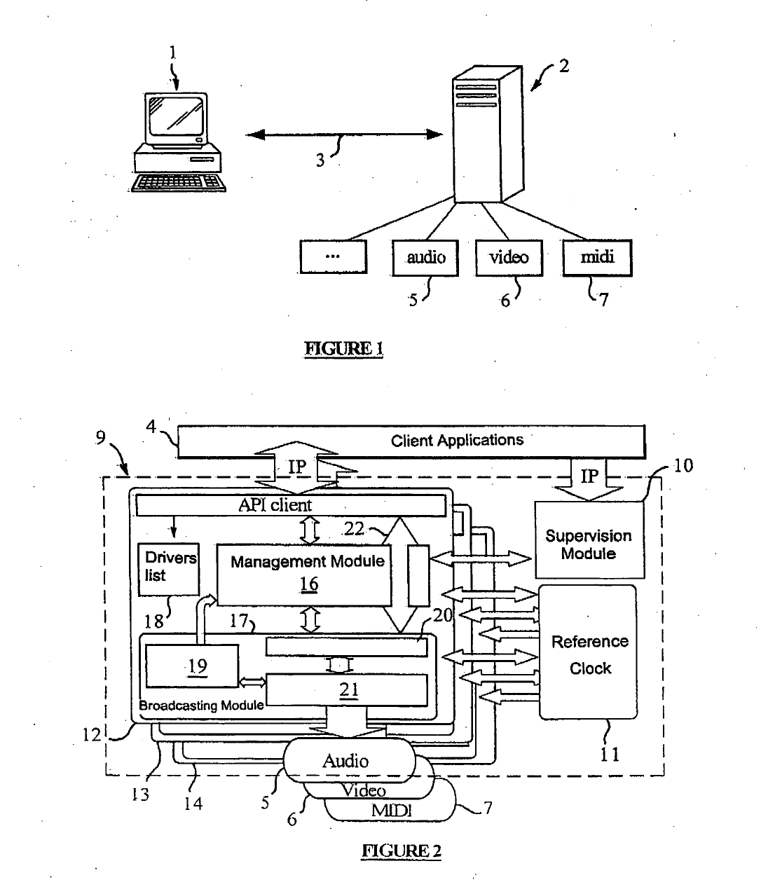

FIG. 2 is a simplified diagram illustrating the broadcasting engine according to the invention in greater detail; and

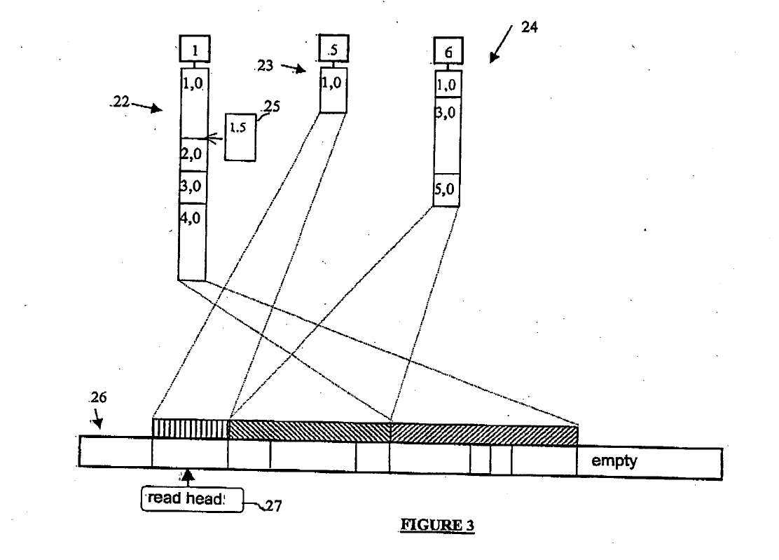

FIG. 3 is a diagram illustrating the insertion of three drop-down lists in a main broadcasting list.

In FIG. 1 there can be seen the overall arrangement of the components included in the broadcasting system according to the invention. A workstation 1 can be seen in which a client application is being used. This workstation 1 can be a microcomputer provided with conventional components for correct functioning within a communication system and using a communication protocol of the server-client type. This work station comprises a database in which media objects are saved. In this work station 1, the media objects correspond to any audio file capable of being broadcast.

The client application housed in the workstation 1 is capable of communicating, according to the Internet protocol (IP), with a broadcasting engine used in a remote server 2. This remote server 2 is connected to broadcasting devices 5, 6 and 7. The broadcasting device 5 is an audio card intended to transmit sound in the context of a radio broadcast. The broadcasting device 6 comprises a video card intended for a video transmission, for example in the context of a televised broadcast. The broadcasting device 7 is a sound card intended for the transmission of “midi” signals. Even though the invention is not thereby limited, the broadcasting system according to the invention will be described for the transmission of audio signals (songs, publicity, news, etc) from a database of the workstation 1 containing audio files to the audio broadcasting device 5. The main function of the client application used in the workstation 1 is to plan broadcast programmes whilst the essential function of the broadcasting engine used in the server 2 is to receive several programmes coming from several client applications and to schedule them in time in order to allow broadcasting at predetermined times.

The broadcasting engine is autonomous, it is separate from the planning, which is carried out by the client application.

In FIG. 2, the element 4 represents several client applications from different workstations accessing the broadcasting engine 9.

Each client application 4, wishing to access the broadcasting engine 9, must firstly be connected to the supervision module 10. This supervision module 10 continuously listens to the requests, according to the IP protocol, coming from the client applications. Each client application transmits an identifier, a password and an IP address through which it desires to transmit its planning to the broadcasting engine 9. When the supervision module 10 validates such a request, it opens a broadcasting session 12. This broadcasting session 12 is associated with the audio broadcasting device 5.

When a client application wishes to transmit video files, the supervision module 10 will then open a broadcasting session 13 associated with the video broadcasting device 6.

When a client application wishes to transmit “midi” files, the supervision module will then open a broadcasting session 14 associated with the midi files broadcasting device 7.

In this way, each broadcasting session 12, 13, 14 is linked with a specific medium. The invention is particularly noteworthy in that the set of broadcasting sessions 12, 13 and 14 is timed by means of a unique reference clock 11. All of the processes used in the different broadcasting sessions are synchronized with respect to the reference clock 11.

According to the invention, the planning of programmes intended for broadcasting by the broadcasting engine is carried out by the client application within the workstation 1. This planning is presented in the form of several drop-down lists 22, 23 and 24 in FIG. 3. The drop-down list 22 comprises four media objects corresponding for example to four songs. This drop-down list 22 is identified by the numerical value “1” within the client application. According to the invention, this drop-down list 22 can advantageously be modified before transmission to the broadcasting engine 9 by including, for example, a media object 25 between the first media object “1.0” and the second media object “2.0”. This inclusion is made possible by the fact that the media objects are encoded by floating point numbers. Therefore the included new media object can assume the value “1.5”.

The drop-down list 23, identified by the numerical value “5”, comprises a single media object.

The drop-down list 24, identified by the numerical value “6” comprises three media objects whose positions are encoded by the floating point numbers “1.0”, “3.0” and “5.0”. The two extreme media objects in the drop-down list 24 correspond, for example, to jingles announcing and terminating a commercial break corresponding to the central media object (whose position is encoded by the number “3.0”).

Preferably, each media object comprises its broadcasting duration and its absolute start time, that is to say the exact time at which it must be broadcast. This absolute start time is a number of microseconds calculated from the 1^{st} Jan. 2000 and encoded as an integer in 64 bits.

All of the drop-down lists of a same client application do not necessarily correspond to a continuous broadcast, furthermore they can be transmitted to the broadcasting engine 9 at different times.

In FIG. 2, when the client application 4 is connected to the broadcasting session 12 for a transmission of the drop-down lists 22, 23 and 24, a driver manager 18 lists all of the audio drivers in its possession and transmits them to the client application 4. The drop-down lists 22, 23 and 24 will then be transmitted after the client application has transmitted its choice on the type of driver to use for reading and broadcasting the media objects contained in these drop-down lists. The communication between the broadcasting session 12 and the client application 4 is carried out via an API (“Application Program Interface”) client application program interface 8.

The drop-down lists transmitted to the broadcasting engine 9 are accumulated in a management module 16. These drop-down lists will then be inserted in a main list 26 (FIG. 3) according to their absolute start times. The broadcasting of the media objects is obtained on the basis of this main list. In FIG. 3, it can be seen how the drop-down lists 22, 23 and 24 are disposed for a continuous broadcast. By way of illustration, a read head 27 reads the media objects directly from the main list 26. The disposition of the drop-down lists in the main list is carried out in response to an instruction sent by the client application. In order that these drop-down lists may be thus disposed in the main list, the absolute start times (at least that of the first media object of each drop-down list) and the duration of each drop-down list must be known. These data are either transmitted by the client application or calculated by the management module just before the insertion of these drop-down lists in the main list. It is the client application, which transmits the instructions, and the information necessary for the insertion of the drop-down lists in the main list.

The main list can comprise empty zones, which can be filled with drop-down lists transmitted before the broadcasting. The client application can therefore transmit drop-down lists, which are accumulated in the management module and independently transmit commands for the insertion of these lists in the main list. These commands can correspond to the following instructions:
place the drop-down list X in the main list;
calculate the duration of the drop-down list X;
calculate the duration of the drop-down list X and the absolute time of the drop-down list X;
calculate the duration of the drop-down list X and calculate the absolute time of the drop-down list X and place the drop-down list X in the main list.

In FIG. 2, the broadcasting session 12 also comprises a broadcasting module 17 managing the drivers necessary for the broadcasting of the media objects.

This broadcasting module 17 comprises detection and decoding applications 19 capable of determining the format of the file corresponding to each media object, for example by processing the header of such a file, and of encoding that file in a generic format. Such an encoding can, for example, correspond to the translation of files in the AVI, MPEG 2, etc. format into a file in the RGB format; a start file in the WAV, WMA or MP3 format, or an AIFF file into a file in RAW format. The files thus encoded are then transmitted to an output interface 21 connected to the broadcasting device 5. The output interface 21 can directly access the main list 26 managed by the management module 16 via an API 20.

Furthermore, the broadcasting module 17 can obtain the information relating to the driver directly from the Client API 8 via a direct link 22.

The system according to the invention also makes it possible to deal with emergency situations. For example, it is possible to include a priority drop-down list coming, for example, from a client application, in a main list instead and in place of all or part of one or more pre-inserted drop-down lists. It is then possible to completely cancel a drop-down list that is pre-inserted and partially covered by the priority list. It is thus possible to create an empty zone. The broadcasting engine can automatically recalculate the absolute start times of the pre-inserted drop-down lists in such a way as to set them in a continuous manner at the end of the priority drop-down list.

The present invention also makes it possible to manage situations directly (“live”). This corresponds to drop-down lists for which the duration is not defined. Such a drop-down list will be switched off by a remote control message or by the insertion of a predetermined drop-down list. The broadcasting engine therefore comprises means for recalculating all of the absolute start times.

A remote control message is a command coming from a client application or elsewhere (satellite synchronisation coming from a remote control server). All remote control commands arrive at the broadcasting engine via the API 8. Each remote control message is linked with a media object. These messages comprise read, pause and stop commands, etc. Preferably, these commands cannot be exeduted in predetermined time periods, for example during the broadcasting of the media object.

The invention is not of course limited to the examples that have just been described and many variations can be applied to these examples without departing from the scope of the invention.

1-23. (cancelled)

24. Media broadcasting system comprising at least one client application (4) and a broadcasting engine (9), the client application comprising:
generating means for generating at least one drop-down list (22, 23, 24), this drop-down list comprising at least one media object intended for broadcasting,
transmission means for transmitting the drop-down list to the broadcasting engine (9),
the broadcasting engine (9) comprising:
a broadcasting session (12, 13, 14) comprising a management module (16) capable of receiving the drop-down list coming from the client application (4) and of inserting that drop-down list in a main list (26) comprising a plurality of drop-down lists, and a broadcasting module (17) capable of broadcasting the content of that main list by means of a media broadcasting device (5, 6, 7),
a supervision module (10) for authenticating a client application (4) wishing to access the broadcasting engine and for opening at least one broadcasting session (12, 13, 14) if appropriate;
characterized in that the broadcasting engine (9) comprises a reference clock (11) for synchronizing all of the components of the broadcasting engine, and in that the first media object in the drop-down list contains an absolute start time corresponding to the time of its broadcasting, this absolute start time being a number of microseconds obtained with respect to a predetermined time origin.

25. System according to claim 24, characterized in that the broadcasting engine and the client application are disposed in two separate processing units (1, 2) communicating according to a communication protocol for communication networks such as the Internet protocol (IP).

26. System according to claim 24, characterized in that the broadcasting engine comprises means for opening a plurality of different broadcasting sessions, each one being dedicated to a predetermined type of media.

27. System according claim 24, characterized in that the predetermined time origin is the first of January of a given year, and the absolute start time is an integer in 64 bits.

28. System according to claim 24, characterized in that the management module comprises means for determining the duration of each media object and the absolute start time of that media object.

29. System according to claim 24, characterized in that each media object comprises a numerical value corresponding to its broadcasting position within the drop-down list.

30. System according to claim 29, characterized in that each numerical value is a floating point number.

31. System according to claim 29, characterized in that for a drop-down list comprising a plurality of media objects, the numerical values corresponding to the broadcasting positions do not form a series.

32. System according to claim 24, characterized in that each drop-down list comprises a unique identification number.

33. System according to claim 24, characterized in that the broadcasting session comprises means (19) for encoding any media object according to a predetermined broadcasting standard.

34. System according to claim 24, characterized in that the management module comprises means for substituting all or part of a media object in the main list by another media object.

35. System according to claim 24, characterized in that the broadcasting engine comprises a list of drivers (18) from which the client application chooses a driver according to the media object contained in the drop-down list transmitted to the broadcasting engine.

36. System according to claim 24, characterized in that the supervision module comprises means capable of opening a broadcasting session associated with a broadcasting device consisting of an audio broadcasting card.

37. System according to claim 24, characterized in that the supervision module comprises means capable of opening a broadcasting session associated with a broadcasting device consisting of a video broadcasting card.

38. System according to claim 24, characterized in that the supervision module comprises means capable of opening a broadcasting session associated with a broadcasting device consisting of a fireworks transmitter.

39. System according to claim 24, characterized in that the supervision module comprises means capable of opening a broadcasting session associated with a broadcasting device consisting of a laser projector.

40. Method of broadcasting media between at least one client application and a broadcasting engine, this method comprising the following steps in the client application:
generation of at least one drop-down list, this drop-down list comprising at least one media object intended for broadcasting,
transmission of the drop-down list to the broadcasting engine,
this method furthermore comprising the following steps in the broadcasting engine:
reception of the drop-down list by a management module and insertion of that drop-down list in a main list comprising a plurality of drop-down lists,
broadcasting the content of that main list by a broadcasting module by means of a media broadcasting device,
authentication, by a supervision module, of a client application wishing to access the broadcasting engine and opening of at least one broadcasting session if appropriate, this session comprising, in particular, the management module and the broadcasting module,
characterized in that it furthermore comprises a step of synchronizing all of the components of the broadcasting engine, and in that the first media object in the drop-down list contains an absolute start time corresponding to the time of its broadcasting, this absolute start time being a number of microseconds obtained with respect to a predetermined time origin.

41. Method according to claim 40, characterized in that the client application accesses a broadcasting session only after being validly identified in the supervision module.

42. Method according to claim 40, characterized in that when the client application is connected to the management module, the broadcasting engine transmits a list containing all of the available drivers, the client application then transmits the drop-down list accompanied by drivers suitable for the broadcasting of the media objects in the drop-down list.

43. Method according to claim 40, characterized in that the management module inserts the drop-down list in the main list in response to a command coming from the client application.

44. Method according to claim 40, characterized in that, at the time of the transmission of the drop-down list to the broadcasting engine, the client application also transmits at least one absolute start time corresponding to the time of broadcasting of the first media object in the drop-down list.

45. Method according to claim 44, characterized in that at the time of the insertion of the drop-down list in the main list, the management module determines the duration and the absolute start time of each media object.
